(19) United States
(12) Patent Application Publication
(10) Pub. No.: US 2017/0010671 A1
(43) Pub. Date: Jan. 12, 2017

(54) HAPTIC INTERFACE WITH LOCALIZED FEEDBACK

(71) Applicant: 8982406 CANADA INC., Montreal (CA)

(72) Inventor: Kamran Ghaffari Toiserkan, Montreal (CA)

(21) Appl. No.: 14/796,068

(22) Filed: Jul. 10, 2015

(51) Int. Cl. G06F 3/01; B25J 13/02; G09G 5/00; G06T 19/00; G06F 3/16

(52) U.S. Cl. CPC G06F 3/016; G06T 19/006; G06F 3/167; G09G 5/006; B25J 13/025

(57) ABSTRACT

Improvement to haptic systems and methods whereby environmental information is provided to a user via audio output device. The audio output device may be provided on a user-manipulable portion of a haptic robotic interface, e.g. a kinesthetic interface. The haptic robotic interface at least partially recreates a virtual environment by providing haptic feedback. The audio output device may provide sound from a source in the virtual environment which may be collocated with the user-manipulable portion of the robotic interface. The audio output device may provide other environmental information on the virtual environment such as proximity information on the proximity of an obstacle. This may be used in, e.g. telemanipulation operations where proximity information may be used to provide warning prior to collision of the slave device with an obstacle.

### TECHNICAL FIELD

The current invention relates to the field of virtual reality, where human sensory experiences are recreated to simulate real or imaginary environments. More particularly, the current invention relates to the field of haptics, which uses the sensation of touch to emulate interaction with a simulated environment, as well as to the field of audio virtual reality, which includes techniques and devices to provide aural effects for imitating sounds and localization of the sound sources within the simulated world.

### BACKGROUND

Humans always tried to reproduce experiences of their environment with different tools. The creation of paintings and sculptures goes back to the early stages of human history, however the term of virtual reality (VR) and its existence as district technical field can be dated to the 1980s.

With the development of robotics, electronics and computers the reproduction of various haptic, visual and aural sensations became possible. Haptics consists of the tactile sense, which is the feeling of touch generated by the mechanoreceptors of the skin, and the kinesthetic sense detected by the receptors about muscles, tendons, joints, and other body parts. Haptic feedback provides important information on the forces, motion, shape, and the surface quality of the interacting elements of the simulated environment which develops the feeling of physical interaction with a virtual environment. The illusion of reality created by haptic feedback can be considerably enhanced by graphical representation of the simulated environment, known as visual feedback.

Further enhancement of the user VR experience is delivered by reproducing the sounds associated with the simulated environment. Audio feedback attempts to provide the user with complementary information about the simulated environment such as the sounds related to the virtual reality environment portrayed.

Thus a virtual reality environment tool may comprise haptic devices as well as visual feedback and audio feedback.

Kinesthetic haptic interfaces are robotic devices that are used to transfer the kinesthetic perception of direct manipulation of the simulated environment to the user. Applications of such systems vary from gaming and training interfaces like force feedback steering wheels and pedals of car simulators to surgical master-slave robotic systems like the da Vinci® surgical system.

### SUMMARY

The current document discloses a solution for generating sound effects to enhance haptic virtual reality applications. A haptic virtual reality system may consist of a kinesthetic feedback haptic interface, which can be a grounded robotic device providing kinesthetic force feedback, or providing or sensing motion. In the present solution one or more speakers (or other devices which are able to play sound) are attached to the moving parts or to the housing of the said interface to generate sound effects related to the events within the virtual environment near to their virtual source or to be used for arbitrary purposes defined by the user. This way a realistic aural experience can be reached, since spatial properties of the generated sound (e.g. location, orientation, Doppler effect and possibly echoes) do not have to be computed.

One or more microphones (or sound capturing devices) can also be attached to the interface—similar to the speakers. This makes it possible to capture interaction sounds with an actual physical environment which can be recorded and played back in a similar virtual interaction or can be streamed in real-time to one or more of the said haptic interfaces to reproduce the captured sounds for example in a master-slave tele-operation haptic application.

Similar to the speakers and the microphones the system can be extended by a range sensor which can sense the distance between specific points of the interface and objects in the physical environment. The signal of the range sensor can be used for sound feedback by the speakers or by the position control of the interface.

In accordance with a first non-limiting embodiment is provided a haptic robotic interface for recreating a virtual environment in a real environment. The haptic robotic interface comprises a grounded portion configured for being in a grounded configuration with respect to the real environment in which the haptic device is located. The haptic robotic interface also comprises a user-manipulable portion movable by a user with respect to the grounded portion. The haptic robotic interface also comprises at least one haptic feedback device in mechanical connection to the user-manipulable portion, the haptic feedback device being actuatable under an input to apply a force to the user-manipulable portion to simulate the application of a force in the virtual environment. The haptic robotic interface also comprises an audio output device located on the user-manipulable portion providing environmental information on the virtual environment.

In accordance with another non-limiting embodiment is provided a telemanipulation system comprising a first robotic interface and a second robotic interface. The first robotic interface is for recreating in a first real environment a virtual environment simulating a second real environment. The first robotic interface comprises a grounded portion configured for being in a grounded configuration with respect to the first real environment; a user-manipulable portion movable by a user with respect to the grounded portion; at least one haptic feedback device in mechanical connection to the user-manipulable portion, the haptic feedback device being actuatable under an input to apply a force to the user-manipulable portion to simulate the application of a force in the virtual environment; an audio output device located on the user-manipulable portion providing environmental information on a remote environment; and a first robotic interface communication interface. The first robotic interface communication interface is configured for transmitting in response to a user manipulation a state data indicative of the user manipulation, and receiving environmental information data. The second robotic interface is for being controlled in the second real environment. The second robotic interface comprises an actuatable portion configured to be actuated in the second real environment in response to the state data indicative of the user manipulation; a grounded portion configured for being fixed relative to the actuatable portion such that when actuated the actuatable portion moves in relation to the a grounded portion; an environmental information sensor configured for sensing an environmental condition and for generating an output representative of the environmental condition; a second robotic interface communication interface. The second robotic interface communication interface is configured for receiving from the first robotic interface the state data from the first robotic interface and providing actuation data to the actuatable portion, and generating on the basis of the output of the environmental sensor environmental information data for transmission to the first robotic interface.

In accordance with another non-limiting embodiment is provided a method of creating a realistic virtual environment using a haptic robotic interface device in a real environment. The method comprises accepting user manipulations on a haptic robotic interface at a user-manipulable portion, the user manipulation corresponding to manipulation commands for an object in the virtual environment. The method further comprises providing haptic feedback to the user-manipulable portion to simulate the virtual environment. The method further comprises receiving from an external source environmental information data representative of environmental information. The method further comprises providing at an audio output device on the user-manipulable portion an audio representation of the environmental information.

### BRIEF DESCRIPTION OF THE DRAWINGS

The invention will be better understood by way of the following detailed description of embodiments of the invention with reference to the appended drawings, in which:

FIG. 1 is a perspective view of a robotic haptic interface according to a first non-limiting example of implementation;

FIG. 2 is a front elevation of a user-manipulable portion of a robotic haptic interface according to a non-limiting example of implementation;

FIG. 3 is a front elevation of a user-manipulable portion of a robotic haptic interface according to another non-limiting example of implementation; and

FIG. 4 is a perspective view of a telemanipulation system comprising two robotic interfaces according to a non-limiting example of implementation.

### DETAILED DESCRIPTION

In a virtual reality environment, producing interaction sounds that can be perceived by the user in a realistic way has been considered difficult due to various reasons. For instance, since the sound producing device is not co-located with the virtual source of the sound, the human can recognize discrepancy/contradiction between the perceived and expected sounds considering the ongoing visual and/or physical experience.

A solution to this problem is to use head-related transfer functions (HRTFs) to characterize how an ear receives a sound from a point in space using a fixed-location speaker or speakers. However, these types of solution have some limitations. In particular, it is not, for most setups, possible to achieve perfect quality and positional characteristic for a sound. Moreover, HRTF techniques require high computational time and development time and are highly dependent on the type and location of the employed speakers. When using external speakers, e.g. to synthesize binaural sound for headphones, the usage of speakers or earphones/headphones needs additional wiring and installation in the virtual reality system may reduce the comfort of the user. Other issues to overcome when attempting to create a realistic sound include signal processing issues. For example, if attempting to recreate a location and/or effect for a sound, the effect imposed on the sound be received differently for different individuals having different hearing characteristics.

Herein we provide a solution to, inter alia, the problem of synthesizing realistic sound data for an associated event.

In one solution, artificial sound may be synthesized to correspond to an event, e.g. a remote event in a haptic telemanipulation environment. Another solution involves faithful reproduction of actual event sounds, which is useful in particular when synthesizing artificial sounds is not possible or optimal, e.g. when the computational power is unavailable or when the type of events for which sound must be created is not known in advance and cannot be provided for by stored sound banks or by real-time algorithms.

Herein we also provide a solution to, inter alia, the issue of user's lack of information on the surrounding physical objects, e.g. in remote environments, especially in telemanipulation applications. In particular is provided a solution providing a user with environmental information, e.g. knowledge of the surrounding physical objects, which can be useful for various purposes such as avoiding hard impacts without slowing down the motion in within the entire workspace.

In particular, herein is provided a haptic device that provides environmental information to or from a user. In particular, the haptic device may provide a link between a real environment in which a user exists and a virtual environment recreated at least partially by the device. In one particular example where the device is a telemanipulation device and the virtual environment is a representation or simulation of a remote environment at which telemanipulation occurs, the link may be an audio link, unidirectional or bidirectional, between the remote environment where manipulation occurs and the real environment of the user doing the manipulation.

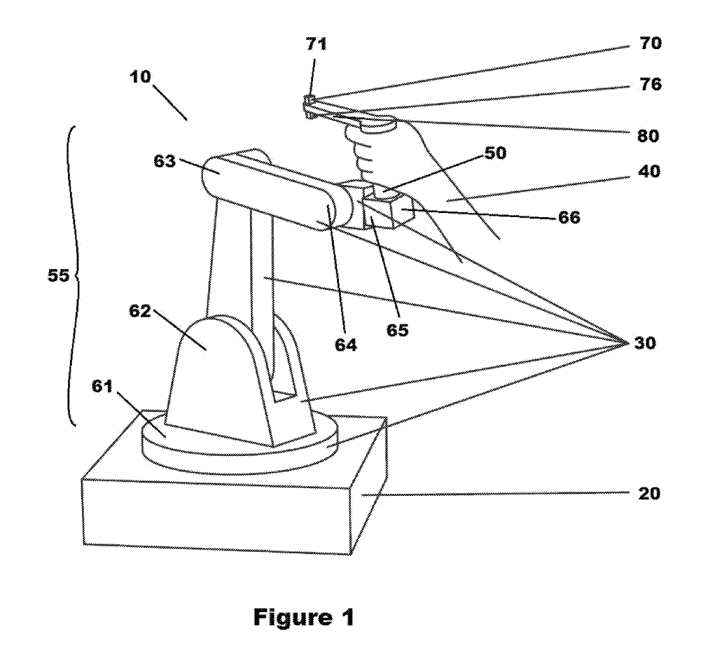

FIG. 1 illustrates an exemplary embodiment where a robotic interface 10 is provided. In this example, the robotic interface 10 comprises a grounded portion 20 and a moving portion 30. As shown, the exemplary robotic interface 10 is a 6 axis robot, although other robotic interfaces can be used, in particular robotic interfaces employing that any kind of robotic device which can provide force feedback and/or motion desired by various applications, e.g. a low degree-of-freedom robot like a Scara robot, Cartesian robot or a redundant robot with more than 6 degree-of-freedom.

The robotic interface 10 of this example is a haptic device and more particularly a kinesthetic haptic device that can be manipulated by a user 40. In this respect, the robotic interface 10 comprises user-manipulable portion(s). In this particular example, the robotic interface 10 can be grasped by the user 40 at a grip 50 which is a part of user-manipulable portion 55. Here the moving portion 30 is the user manipulable portion 55, as the moving portion 30 is movable by manipulation by a user. In this example, the robotic interface 10 is a general-purpose robotic interface, and the grip 50 can be adjusted or changed as a function of the task it is meant to emulate.

The robotic interface 10 exists in a real environment. The real environment is the real physical or tangible world surrounding the robotic interface 10, which may include a surface on which the robotic interface 10 is placed and free space around the robotic interface 10 which permits the moving portion 30 to be moved unimpeded along its full range of motion. In other examples, the real environment may include other structures on to which a haptic robotic device may be affixed, e.g. clamped to.

A grounded portion is a portion that is fixed with respect to a reference. In particular in the example shown here, the grounded portion 20 is grounded with respect to the real environment, that is to say that it remains generally fixed with respect to the real environment. In that regard, the grounded portion 20 is configured to be grounded. In the example illustrated, the grounded portion 20 is a base that comprises a flat bottom surface that is adapted to be laid on a flat surfacetop like a tabletop. Optionally, the grounded portion 20 may be adapted to be kept in place on its own, without requiring a user to hold it in place. In this example, the grounded portion 20 is made of heavy material such that it is weighed down and remains on the surface on which it is laid even as the user-manipulable portion 55 is being manipulated. In other embodiments, the grounded portion 20 could comprise suction cups for holding it onto a flat surface. The grounded portion may also include other means for grounding it with respect to a real environment, for example a clamp for clamping it to an edge of a table or another structure.

The robotic interface 10 recreates a virtual environment by providing haptic feedback representative of forces applied on the user manipulable portion in the virtual environment. The virtual environment is an environment that is collocated with, but different from, the real environment in which the robotic interface 10 is located. The virtual environment is a virtual world at least partially recreated by the robotic interface 10 which is collocated with the real environment such that at least a part of the robotic interface 10's user-manipulable portion 55 is in corresponding locations in the real and the virtual environment. More particularly the location of at least a part of the user-manipulable portion 55 (in this example the location of the grip 50) may overlap in the real and virtual environment.

The virtual environment is recreated by the robotic interface 10 by way of haptic feedback. Although the virtual environment is collocated with the real environment, is different from the real environment. For example, although in the real environment, the area around the user-manipulable portion 55 may be clear of obstruction, in the virtual environment there may be an obstruction in at least one possible direction of movement for the user-manipulable portion 55 which is recreated by causing force feedback to be applied to the user-manipulable portion 55 impeding movement in at the obstruction. This is of course just an example as the reader is to appreciate that there can be a number of different properties of the virtual environment recreated by haptic feedback. For example a surface on which the user-manipulable portion 55 is moved may be provided a virtual high-friction or bumpy feel by applying corresponding haptic feedback, and the surface itself may be virtual and recreated by applying a forced inhibition of travel of the user-manipulable portion 55 at the virtual surface.

Thus, the robotic interface 10 is manipulable in the real environment to cause a manipulation in the virtual environment and may emulate a virtual robot such as a bone saw or other surgical tool or a welding tool to emulate a variety of tasks such as a sawing task or a welding task or a surgery task. When a user manipulates the robotic interface 10, it does so in the real environment where the robotic interface 10 really exists and by applying real force, for example, to the robotic interface 10. The robotic interface contributes to a virtual environment by creating haptic feedback that doesn't necessarily correspond to anything in the real environment. For example, if the grip 50 of the robotic interface 10 can be pushed forward, the robotic interface 10 may exert via force feedback to emulate a resistance presented by an object that is not in the real environment. This is an example of haptic, in this case kinesthetic, feedback that contributes to a perception of an environment, the virtual environment, that is not identical to the real environment of the robotic interface 10.

The haptic feedback can be provided according to a choice of implementations (e.g., impedance control, admittance control, hybrid impedance-admittance). In the present example, the robotic interface 10 comprises a controller (not shown) and uses an impedance control approach. The robotic interface 10 also comprises a haptic feedback device to provide haptic feedback, which may include kinesthetic and/or tactile feedback to the user-manipulable portion 55. The haptic feedback device is in mechanical communication with the user-manipulable portion 55 and is actuatable to apply a force to the user-manipulable portion to simulate application of a force in the virtual environment being recreated by the robotic interface 10. The haptic feedback device may comprise one or more brushed or brushless DC motor or any other type of actuator appropriate for the system.

The controller is in communication with the haptic feedback device to control the application of force thereby, and optionally to receive information therefrom, for example where the haptic feedback device provides positional or state information. In this way, the haptic feedback device may itself act as a sensor providing information on the state of the robotic interface 10. The state of a device may comprise information on configuration and/or motion of its constituent parts such as joint and/or component positions, velocities (translational or rotational) and acceleration. The state information may include information on forces applied to the haptic interface 10, e.g. at the user-manipulable portion 55. Any suitable known mathematical modeling may be used to define the state.

The haptic feedback device is in mechanical connection to the user-manipulable portion 55, to provide haptic feedback thereto. In the present example, the haptic feedback device is also in mechanical connection with the grounded portion to apply a force onto the user-manipulable portion 55 with respect to the grounded portion 20. In this manner the haptic device may provide kinesthetic feedback. The force applied by the haptic device may be in any direction of possible travel of the user-manipulable portion 55. The haptic device may also be in mechanical connection with multiple parts of the user-manipulable portion 55 so as to apply a force between different parts of the user-manipulable portion 55. In the present example, the haptic feedback device comprises six DC motors which are embedded within the robotic interface 10. The six DC motors are provided within different hinges/connections of the robotic interface 10, connecting one side of each hinge/connection to the other to apply a relative force in the direction of freedom of the hinge/connection. In the example illustrated in FIG. 1, DC motors are provided at pivot table 61, shoulder joint 62, elbow joint 63, wrist joint 64, wrist pivot point 65 and grip pivot point 66. Together these form a haptic feedback device that provides haptic feedback, in this case force feedback including at least kinesthetic feedback, to the user-manipulable portion 55.

In accordance with the control scheme used, the robotic interface 10 has a controller that receives information on the state of and/or external forces applied to the robotic interface 10 or other relevant information using position and/or force and/or other sensors and then feeds back appropriate forces to imitate an interaction or a desired behaviour. The controller evaluates relevant information such as the configuration, geometries, and properties of the simulated environment. For example, in a basic impedance control approach, the configuration/motion of the haptic device, and thus the human hand, is detected by position sensors (e.g. optical encoders). A computer then compares this information to relevant data in the simulation (e.g. object geometries, relative position of the objects) to determine the proper haptic forces. The information on the desired forces are then sent to the onboard electronics of the haptic device (using analogue or digital signals, wired or wirelessly) that will eventually drive the actuators of the device (e.g. DC motors) to produce/feedback the computed forces to the human hand. Other sensors in addition to, or instead of, the position sensors may be used to determine the velocities, or acceleration of the device. Regardless of the sensor, the position/motion of the device always is generally determined in accordance with the impedance control scheme. In the present example, the robotic interface 10 comprises position sensors since these are practical and accurate.

The virtual environment may be a fictitious environment, that is, an environment that is not linked to a physical environment elsewhere. For example in the case of a virtual reality training simulator where visual feedback provides a virtual view (e.g. via a head-mounted 3D display) of a training task. In a more specific example, the robotic interface 10, may simulate a bone saw in a surgery simulator virtual environment. In that example, the grip 50 of the robotic interface 10 may correspond to a grip of a virtual bone saw. The virtual environment recreated by the robotic interface 10 may therefore provide various types of bodies and sawing tools for sawing. A visual feedback device may simultaneously provide a visual recreation of the virtual environment so that the user may see the virtual sawing tool and operation theater with a body on which to perform surgery.

The robotic interface 10's controller comprises a communication interface for communicating with a computer, for providing the computer with state data indicative of the state of the robotic interface 10 and other relevant information such as audio information forces, etc. . . . and for receiving from the computer haptic feedback data indicative of the haptic feedback to be applied by the haptic feedback device. The controller communicates with the haptic feedback device and/or sensors to generate the state data to transmit and to translate haptic feedback data into control signals to the haptic feedback device. Optionally, the controller may also generate user command data indicative of a user command, however, user commands will typically be represented by state data showing an altered state of the haptic manipulation device as a result of the user manipulation and as such user command data will typically be embodied by state data. Generally speaking, a user provides commands by manipulating the user-manipulable portion 55. The controller detects the user manipulation, in this example on the basis of the state information and derives generates state data indicative of the user manipulation. In this example the state data is indicative of the user manipulation because it indicates a change of state caused by the user manipulation. In the present example, the state data comprises information indicative of the position of the user-manipulable portion 55, and the state data therefore serves as the user command data.

In the present example, the robotic interface 10 may be in communication with a computer which computes the virtual environment and provides haptic feedback data to the robotic interface 10 to recreate the virtual environment at the haptic interface 10. For example, the computer may be running a surgery simulation software which provides the context for the virtual environment, and the computer may also drive a visual feedback device which also recreates the virtual environment but visually. In this example, the state data is provided to the computer which creates the appropriate changes to the virtual environment in response to the state data, and provides feedback data (visual and haptic) to the visual and haptic devices. Thus although the robotic interface 10 recreates the virtual environment, this recreation may be a contribution to a larger recreation of the virtual environment using other tools or devices, such as the visual feedback device mentioned herein that provides a visual depiction of the virtual environment to a user. For example, in one embodiment a virtual reality system may include the robotic interface 10 providing haptic feedback and a 3D head-mounted display providing a visual representation of the virtual environment to the user. Thus the user may feel and see the virtual environment using the system.

The communication between the communication interface and the computer and/or other robotic interface follows a suitable communication protocol. Generally communication can be done in serial or parallel, either wired or wireless, using standard computer ports/hardware such as LAN, USB, Serial port, Parallel port, PCIe, Wifi; or any custom-made hardware connected to the computer.

Although the virtual environment may be created using an external computer which provides the virtual environment context as described above and computes the feedback to be provided, in alternative embodiments, the entire control embodied by the computer may be implemented by onboard logic on the robotic interface 10, in which case there is no need for an external computer. In that case, the onboard computer of the haptic device can act as a stand-alone system that can be reprogrammed to do different simulations.

Conversely, the virtual environment may be the recreation of a real environment. In particular, the robotic interface 10 may be a telemanipulation tool for remotely controlling a slave device.

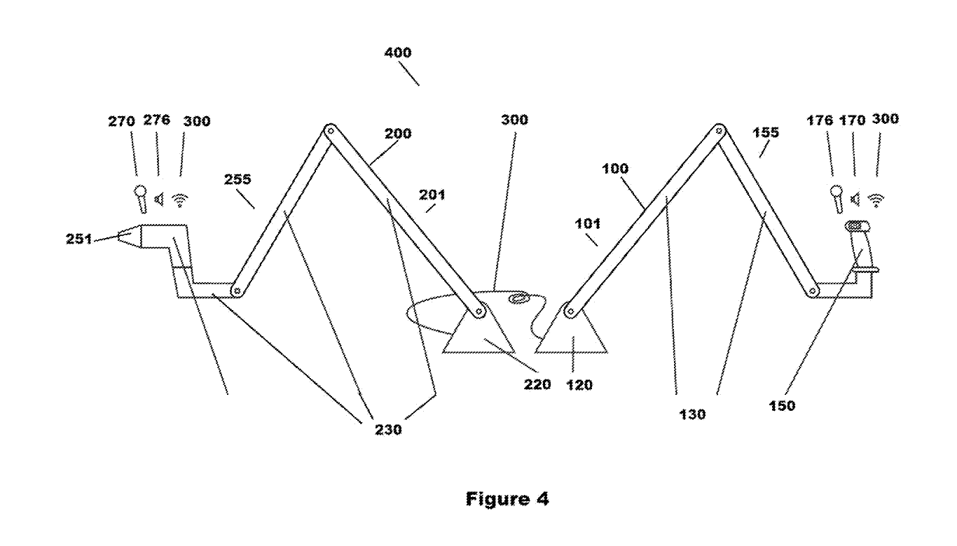

FIG. 4 illustrates an example of a telemanipluation system 400. The telemanipulation system 400 comprises a first robotic interface 100, in this example a robotic interface similar in function, though not drawn identical in form, to robotic interface 10 of FIG. 1. The telemanipulation system 400 also comprises a second robotic interface 200. In a first example which shall be described herein, the first robotic interface 100 is a master device 101 and the second robotic interface 200 is a slave device 201. In the master-slave relationship, the master device 101 is subject to manipulation by a user and the slave device 201 is controlled by the master device in accordance with the manipulations performed by a user on the master device.

The master device 100 provides to the slave device state data indicative of a user command to actuate the slave device 200 in a certain way. The slave device in turns receives the state data and responds by being actuated in the way requested by the user.

The master device 100 and the slave device 200, in use, each belong in respective first and second real environment. Like with the robotic interface 10 of FIG. 1, the real environment of each device is the actual physical environment of the device itself. Since in telemanipulation operations the two devices are typically not in the same place, the two environments may not be identical. Thus while the master device's physical environment may be free of obstruction in the range of motion of its moving parts, the slave device 200 may have obstructions to the actuation requested, e.g. in a direction of motion it is commanded by the user of the master device to move. The slave device 200 provides feedback data back to the master device 100 which translates this data to haptic (e.g. tactile or kinesthetic) feedback applied at the master device 100. In this manner the master device 100 recreates a virtual environment that, by virtue of the haptic feedback it provides, simulates the real environment of the slave device 200.

The master device 101 is a robotic interface that, although is not drawn identical in form to the robotic interface 10 of FIG. 1, is similar to (and alternatively may be identical in all ways not otherwise described herein to) the robotic interface 10. Thus the master device comprises a grounded portion 120 and a user manipulable portion 155, which includes one or more moving parts 130 and which includes in this example a grip 150. The master device 101 comprises a controller similar to the controller of the robotic interface 10. The master device 101 comprises at least one haptic feedback device, which in this case is also a set of DC motors provided at the hinges/connections of the user-manipulable portion 155. And the master device 101 also comprises state sensors, in this case position sensors from which is derived (in this example by the controller) a state of the master device 101, including in this example a position of the user-manipulable portion 155, which in turn is indicative of a user command and serves as user command data. In this example, the master device may also include a button (additional buttons and/or other actuators could also be used); the button being connected to a circuit altogether serving as a state sensor indicating whether the button is pressed by a user.

Thus the master device 101 communicates with the slave device 201 via a communication interface similar to the communication interface of the robotic interface 10. In one particular example, the master device 101 communicates indirectly via a computer that is connected to both the master device 101 and the slave device 201 and which serves as an intermediary therebetween. In this particular example, the master device 101 may function exactly like the robotic interface 10 does in the context of a fictitious virtual environment in that the master device 101 may communicate uniquely with the computer and be completely agnostic to whether the computer is providing a virtual environment context that is fictitious or that is a representation of a real environment of a slave device.

In the particular example shown here, however, the master device 101 is in direct communication with the slave device 201 via link 300. The master device 101 comprises a communication interface similar to the communication interface of the robotic interface 10 of the example of FIG. 1, however it communicates directly with a communication interface of the slave device 201. In like manner as with robotic interface 10, the master device 101 comprises state sensors providing state information which in this example is also indicative of user commands based on user manipulation. The controller of the master device 101, which comprises a communication interface, generates the state data which in this case is also user command data indicative of user manipulation and transmits it down the link 300. In practice, the communication interface may communicate this information in digital form according to any appropriate protocol understood by the recipient (computer or slave device) and using any suitable communication technology. For example, the link 300 may be bidirectional a serial data link (e.g. a USB link, where the connected devices' communication interfaces comprise a USB interface). Alternatively, the communication interfaces of the master device 101, robotic interface 10, computer and/or slave device 201 may include a WiFi interface for communicating together over WiFi.

The state data is received at the slave device 201 at a communication interface similar to the communication interface of the master device 101.

The slave device 201 is a robotic interface in that it interfaces with the real environment it is in. In this example it is similar to the master device 101 in form, although instead of a grip 150, it comprises a working end 250, which in this case is a bone saw 251. Like the master device 101, the slave device has moving parts 230, together forming an actuatable portion 255. In this example, the slave device 201 also has a grounded portion 220, however it should be understood that in other embodiments the slave device may be ungrounded, e.g. mounted on motorised wheels controlled from the master device using a control interface, e.g. with buttons or a mini joystick on the grip 150 or on the grounded portion 120.

The actuatable portion 255 of the slave device 201 is actuatable, that is to say it can be caused moved or be modified or otherwise exhibit a physical response as a response to a user command received by the slave device 201. In this regard the slave device 201 comprises an actuation device, which in this example is a set of DC motors at each hinge/connection of the actuatable portion 255, which can effect movement of the actuatable portion 255 according to the collective range of motion of its various hinges/connections. Similarly to the master device 101 and the robotic interface 10 of the example of FIG. 1, the actuation device may comprise DC motors, or other suitable motors (e.g. linear motors or pneumatics).

A grounded portion may be grounded by virtue of being fixed with respect to a reference that itself may be moving. For example, in the case of a slave device, a grounded portion may be on a mobile vehicle that itself is moving relative to the real environment. A grounded portion may be fixed relative to a moving portion such that the moving portion moves relative to the grounded portion. In the case of the example shown here, the grounded portion 220 is fixed relative to the actuatable portion 255 such that when the actuatable portion 255 is actuated, it moves relative to the grounded portion.

The slave device 201 comprises a controller which has a communication interface similar to the communication interface of the master device 101, which receives the state data representative of user commands from the master device 101. The controller translates the state data into actuation data which are signals controlling the actuation device, in this example the various DC motors in the slave device 201 to cause the slave device to be actuated as requested by the user at the master device. Thus a user manipulating the master device 101 can effectively manipulate the slave device 201 remotely using the master device 101. As can be appreciated from FIG. 4, the master device 101 and the slave device 201 have similar form configurations and thus motion in the master device 101 can be translated to equivalent motion in the slave device 201. However, it will be appreciated that in other embodiments, the master device and slave device may not necessarily have the same form and the movement imparted to the slave device may not necessarily result from an identical movement in a master device. For example where the slave device comprises a motorised wheeled vehicle and the master device comprises a kinesthetic joystick, a push forward of the joystick may be translated into state data that is received by the slave device and translated into actuation of motors to make the slave device roll forward.

The slave device 201 also comprises sensors, which may be similar to those sensors of the master device 101 and/or of the robotic interface 10 of the example of FIG. 1. In particular, the slave device may comprise position sensors, which may be provided partially or wholly by dedicated sensors. The controller collects information about the slave device 201, for example the position of the actuatable portion 255 using the sensors, applied force using force sensors, or environmental information such as sounds using microphones. Although position and motion sensors are the most popular other sensors such as force sensors, piezo or microphones can also be added which provide information on other aspects of the state of the robot. The controller generates feedback data on the basis of the state information provided by the sensor. If the user provides a command, for example to move the arm of the actuatable portion 255 in one direction, but there is an obstacle in that direction which impedes movement of the actuatable portion 255 despite the controller's instructions to the actuation device to move the actuatable portion 255 in that direction, the controller will determine from the state information that there is an obstacle preventing movement and generate corresponding feedback data. Feedback data may be generated from many other types of sensors, e.g. optical sensors detecting a type of texture (e.g. to provide tactile feedback data) or heat sensor on a saw detecting excessive friction (e.g. translated to a vibration or heating of the grip 150 on the master device 101).

The controller of the slave device 201 transmits via its communication interface the feedback data to the master device 101. The communication interface of the master device 101 receives from the slave device 201 (or in alternate embodiments from a computer receiving such data from a slave device) the feedback data and the master device 101's controller translates feedback data into instruction signals to the haptic feedback device to cause a corresponding haptic feedback to be provided to the user of the master device 101. The robotic interface 10 of the example of FIG. 1 may work in the same way.

The above example has been described in terms of a master-slave relationship where the master device 101 controls the slave device 201 and not vice versa. However, the relationship may be bidirectional. In one particular example, the feedback device on the master device is also suitable as an actuation device and the actuation device on the slave device is also suitable as a feedback device. In particular, the DC motors provided on the slave and master devices may both be capable of providing feedback and actuation as required. In that example, what would otherwise have been the slave device may also include a user-manipulable portion. In one particular example the actuatable portion of the slave device is also a user-manipulable portion, where manipulation of the actuatable portion is detected by the sensors of the device and translated by the device's controller into state data which may also be user command data and transmitted to the other device. The device's controller may also receive feedback data and translate these into control signals for the feedback device (which in this example is also the actuation device) to provide haptic feedback to a user manipulating it.

Likewise what would otherwise be the master device may include an actuatable portion actuatable under state data indicative of user command received at the remote (otherwise slave) device. Like with the remote device, the actuatable portion may in fact be one and the same as what was considered the user-manipulable portion in the master device of the master-slave example. The device's controller may receive of what would otherwise by the master device may also receive user state data and translate this into control signals to the actuation device (which in this example is also the feedback device) to actuate the actuatable portion according to a user command received at the remote device. This otherwise-master device may also create feedback data in the same manner as the slave device 201 and provide it to the remote device.

Thus instead of a master-slave relationship, the telemanipulation system may provide a bidirection relationship where both devices may be master and slave, manipulated and actuated. In one particular example of bidirectional relationship, the telemanipulation system may provide a symmetric relationship where both devices' feedback and actuation mechanism are one and the same.

Returning to the example of FIG. 1, the robotic interface 10 comprises an audio output device 70 on the user-manipulable portion 55. Because the audio output device 70 is on the user-manipulable portion 55, it is manipulated, and more specifically moves, along with the user-manipulable portion 55. The audio output device 70 of the present example includes a small speaker 71 affixed to an extension 80 of the user-manipulable portion 55 which extends outwards from a part on the user-manipulable portion 55, in this case from the top of the grip 50, to a location where the speaker 71 is mounted.

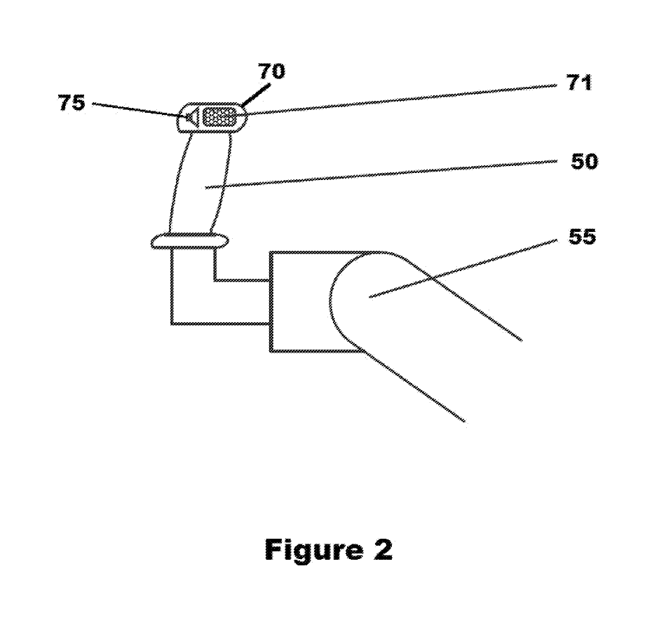

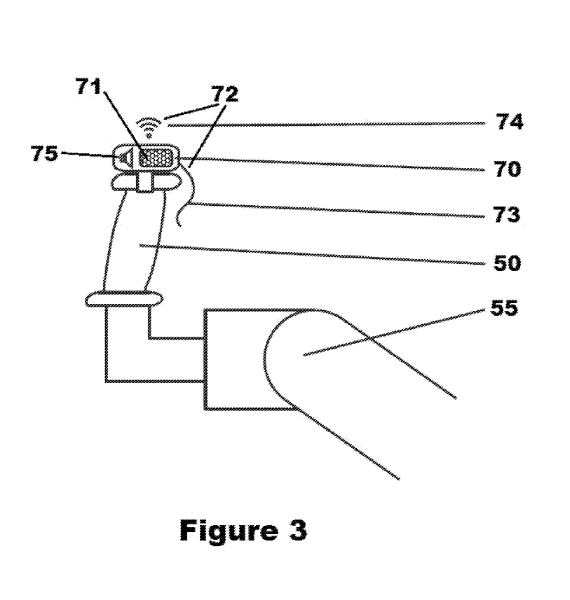

FIG. 2 shows a side view of part of the user-manipulable portion 55 according to one embodiment where the speaker 71 is inbuilt, that is to say it is made integral with the user-manipulable portion 55. In another example, shown in FIG. 3, the speaker 71 is attached to the user-manipulable portion by way of an attachment, for example by one or more screw, plastic snap or other fastener, or by glue or magnets. In the example of FIG. 3 the speaker 71 is attached to the extension 80, although in other examples the extension 80 may be a part of the audio output device 70 and the attachment of the audio output device 70 to the robotic interface 10 may be similarly done by attaching the extension 80 to the user-manipulable portion 55.

The audio output device 70 is configured to provide environmental information on the virtual environment (fictitious or simulating a real remote environment) in audio form. In particular, the speaker 71 may output a sound from the location where it is mounted.

In a virtual reality application, sound may be provided as part of environmental information on the virtual environment. In order to provide the most realistic audio feedback many physical properties of the emulated sound may be considered, such as its frequency and intensity, which in case of a real environment varies depending on time, location and orientation of the sound source as well as its velocity relative to the observer, and other factors. The audio information can be sent from a host computer to the haptic device as analogue or digital signals, and can also be encoded with other control information and sent to the device within the same communication channel. Alternatively, the audio signals can be generated by an onboard electronics on the haptic device.

Accurate spatial localisation of sound has previously been hard to achieve because anterior solutions using speakers that are fixed with respect to the user (such as headphones) or fixed with respect to the real environment and/or room (such as a 5.1 surround sound system) are have serious drawbacks. The computations required for simulating sound localisation with such systems, e.g. using of head related transfer functions (HRTF) (e.g. by measurements or model-based algorithms) which consider one or more of the localization, velocity, orientation of the sound source are burdensome and time consuming which makes them difficult or expensive to implement, particularly if real-time sound is desired. At the same time localisation of sound with such fixed speakers is difficult and generally imperfect and subject to error causing lack of realism. Thus despite significant advancements in tools and techniques for generating 3D sound effects, the achievable quality of effects is limited by factors such as signal processing limitations, computational power, differences in listener's hearing characteristics, etc. . . . .

The audio output device 70 provides a link between the real environment of the user-operated robotic interface (in this example robotic interface 10, but also first robotic interface 100) and the virtual environment recreated by the robotic interface. The audio output device 70 outputs audio information as part of the virtual environment recreated by the haptic device which provides environmental information on the virtual environment. The audio information output may form a part of the virtual environment recreated by the haptic robotic interface

In examples illustrated in FIG. 1 and FIG. 4, the communication interface of the controller of the robotic interface 10 (and first robotic interface 100) is configured to receive environmental information on the virtual environment. The controller transmits audio data to be output by the audio output device in response to the environmental information received at the communication interface.

The communication interface receiving the audio data may be analog signals or otherwise the same communication interface described above, e.g. that is configured to communicate with a device, for example a computer for example over a USB interface. The communication interface may also according to an example of direct connection to a remote robotic interface be configured to receive from the remote robotic interface the environmental information.

In the example shown in FIG. 2, the audio output device 70 is integral with the robotic interface 10, and is in communication with the controller. In this example the controller receives environmental information in like manner as it receives other information, e.g. feedback commands. For example it may receive it over the same serial (e.g. USB) connection. In this example the audio output device is in electrical communication with the controller, specifically the connection to the controller comprises a wire connection over which analog signal driving the speaker 71 is transmitted by the controller. In an alternative embodiment, the audio output device 70 may comprise decoding logic for decoding digital audio data (e.g. an uncompressed audio bit stream or even compressed audio data) and a communication module for communicating with the controller that transmits digital audio data to the audio output device 70 using any suitable protocol and technology (e.g. serial connection or Bluetooth™).

In the example shown in FIG. 3, the audio output device is a detachable device that is provided with its own communication module 72. As has been described, the environmental information may be received at the controller which provides audio data to the communication module 72. In this example, however, the audio output device 70 is configured for receiving the environmental information directly from the source (e.g. external computer or remote robotic interface). As such the communication interface of the robotic interface of FIG. 3 is a distributed communication interface, comprising a first module, e.g. within the controller, which receives feedback data and/or transmits state data/command data, and a second module in the audio output device 70 which receives environmental information data e.g. directly from the source. The communication module 72 of the audio output device 70 of the example of FIG. 3 may be configured for receiving an analog audio signal and driving the speaker 71 with it, however in the example provided here the communication module 72 is a digital communication module comprising suitable hardware for receiving data using digital data transfer technology (in this example a WiFi interface 74 and a serial, e.g. USB, interface 73). The communication module 72 comprises logic for interpreting the environmental information received and translating it into a driving signal for the speaker 71. In particular in this example the communication module comprises a digital decoder for decoding a compressed audio bitstream and a digital-to-analog converter for converting it to an analog speaker driving signal.

It will be appreciated that even in the example of FIG. 2, the audio output device 70 could alternatively comprise the communication module of the example of FIG. 3, and that in both examples the communication module may be configured for receiving environmental information directly from the source, or from the controller which in communication with the source which provides it to the communication module.

Where the communication module of the audio output device 70 is configured for receiving audio data in analog form, it may comprise an analog audio input interface, e.g. an analog sound input port, for example a 3.5 mm phone connector for receiving the audio data.

As shown in FIG. 2 and FIG. 3, the audio output device 70 may also comprise local controls, for example a mute button 75 to mute the speaker 71, or volume controls.

The environmental information received at the robotic interface 10 (and at the first robotic interface 100) may comprise sound, that is to say audio data representing a sound, to be output by the audio output device 70. Specifically, the environmental information may be a sound from a virtual source that is collocated in the virtual environment with the robotic interface 10 in its real environment, or more particularly collocated with the user-manipulable portion 55 in the real environment, or even more particularly with the audio output device 70 in the real environment, or even more particularly with the speaker 71 in the real environment of the robotic interface 10.

In particular the audio output device 70, and more particularly the speaker 71, may be positioned on the user-manipulable portion 55 so as to be collocated with a source of sound in the virtual environment. When the robotic interface 10 recreates a virtual environment, this virtual environment overlaps the real environment of the robotic interface 10 at least at part of the user-manipulable portion 55. For example where a user grips grip 50 of the robotic interface 10 in the real environment, in the recreated virtual environment the grip 50 may simulate a grip of a bone saw. The grip of the virtual bone saw and the grip 50 of the robotic interface 10 are thus collocated. Likewise, in the virtual environment, the source of sound may be located as a certain location relative to the grip 50. Much like the grip 50 of the robotic interface 10 in the real environment is collocated with the grip of the bone saw in the virtual environment, the audio output device 70 and more particularly the speaker 71 may be collocated with source of sound, such that in the real-environment recreation of the virtual environment for the user, the audio output from the audio output device 70 comes from the same location as the sound source. In the bone saw example, if the bone saw comprises a circular drill that has a contact point with the bone a certain distance ahead of the bone saw grip (all in the virtual environment), in the real environment, the audio output device may mounted on an extension 80 in the user-manipulable portion 55 at the same distance from the grip 50 such that the location of the virtual sound source and the location of the audio output device 70 overlap.

In case of haptic virtual reality applications, where different sound effects originate from interaction with virtual objects, their source is commonly located close to the haptic interface of the virtual reality system itself. A speaker attached to the moving parts or the housing of the interface eliminates the need to artificially reproduce the spatial properties of sound effects. To facilitate the generation of sounds related to virtual interactions a further microphone and/or range sensor can be utilized so that the sound of a real interaction can be captured to be played instantaneously or with a delay by the speaker and the proximity of surrounding physical objects can be sensed and related to a produced sound for different purposes, as described further herein.

The virtual environment may comprise a source of sound. This source may be a fictitious source or may have origins in a real, e.g. remote, environment. Because of the common role of the robotic interface 10 as a manipulable tool with which to interact with the virtual environment, oftentimes the sound sources in the virtual environment will be at or near the robotic interface 10 and particularly the user-manipulable portion 55. The sound is considered to be collocated because it is in an area in the virtual environment that is at or adjacent to the area occupied by the user-manipulable portion 55, or the device simulated by the robotic interface 10 in the virtual environment. In one example, where the robotic interface 10 simulates a bone saw in the virtual environment (the grip 50 simulating the grip of a bone saw), there may be a sawing sound that has its source collocated with the robotic interface 10, and more particularly with the user-manipulable portion 55. The providing the sawing sound in audio feedback may be useful since it may provide a user with important environmental information. For example, the bone saw sawing in the virtual material may make certain sounds indicative of the material being sawed by the bone saw, which may indicate, for example, if the saw is being operated correctly or if unintended tissue is being sawed. Together with haptic feedback (e.g. vibration, hard or soft resistance to push) this sound may provide the user with information on the sawing/surgical operation (e.g. indicates when a metallic obstruction such as a bone screw has been hit during sawing). Thus the robotic interface 10 provides sound from a sound source as environmental information by outputting it on audio output device 70.

Advantageously, since the audio output device 70 is collocated in the real environment with the sound source in the virtual environment, a realistic localisation of the sound can be achieved that is not affected adversely by the position of the user's head. Unlike with headphone-based systems and fixed-speaker based systems that assume a particular position of the user's head, in this example no matter how the user orients or moves his head, the sound will be perceived as coming from the location of the sound source. Moreover, since the audio output device 70 is collocated with the sound source, there is no need for expensive multi-speaker systems that moreover add physical complexity to a virtual reality installation in order to reproduce localized sound, and computationally expensive sound localisation algorithms need not be used. Instead, the sound from the sound source can be output directly at the audio output device 70 to achieve a highly robust and realistic audio feedback with accurate localisation with little installation complexity, computational intensity, and also little to no calibration requirements.

Thus the robotic interface 10 may configured so that the audio output device 70 will be collocated with a sound source, e.g. by positioning it or by providing a mount for positioning it at a location where it is expected that a virtual sound source will be when the robotic interface 10 recreates a virtual environment. For example, the robotic interface may be configured for use in a surgical simulator and comprise an extension 80 on which the audio output device 70 (or an attachment point for the audio output device 70) is located on the user-manipulable portion 55 where the saw of the virtual environment will be such that the audio output device 70 can output audio feedback of a saw at a point where the saw of the virtual environment would be in the real environment so as to provide a realistic sound effect.

In certain embodiments, the audio output device 70 may be provided separately for attachment to the user-manipulable portion 55. In such embodiment, the audio output device 70 itself may be configured for being collocated with the sound source, for example by being provided with an attachment point (e.g. with a clamp, screw holes, etc. . . . ) for attaching it to the user-manipulable portion 55 at a point such that it will be collocated with the sound source. Optionally, an extension such at the extension 80 may be provided on the separate audio output device 70 itself, with the attachment point on the extension 80, for attaching to the user-manipulable portion 55.

Since the sound source may move with a virtual device simulated by the user-manipulable portion 55, it may be subject to small but non-negligible movements in space. These relocations may be very difficult to accurately simulate with fixed or head-mounted speakers but could easily be perceived by a human in the real world. By localising the audio output device 70 on the user-manipulable portion 55, the audio output device 70 may move with the user-manipulable portion 55 instantaneously relocating the perceived location of the sound source to a user with movement of the user-manipulable portion 55, resulting in highly accurate and realistic audio feedback.

The human hearing system is fairly sensitive and some seemingly small effects. A factor influencing the audio virtual impression is the relative velocity of the sound source and the listener (vection). The movement of a sound source relative to a listener may be perceptible to the listener. Yet it may not be possible in many systems with fixed or head mounted speakers and limited resources to accurately simulate the effect of movement of a sound source artificially. Moreover, where the relative movement of the sound source and the listener is due to movement of the listener, it may be simply impossible to reproduce the effect of the movement accurately with prior systems if the systems do not have knowledge of the listener's movement. However, with the robotic interface 10, the effect of movement of the sound source relative to the listener is reproduced intrinsically since the audio output device 70 is located on the user-manipulable portion 55 and therefore movement of the user-manipulable portion 55 or of the listener relative to the user-manipulable portion 55 produces the effect of relative movement of sound source and listener.

The environment around a sound source can also have audible effect on the perception of the sound source. Sound echoing is another effect that may be perceptible to a listening; the echoes originating from nearby objects can also be considered when generating sound effects. Likewise dampening by obstacles impeding travel of the sound (or sound-permeable obstacles that modify the sound) are environmental factors that can affect the perception of a sound. Algorithms exist for computing the effect of a virtual environment to a sound source. Where the virtual environment comprises sound-reflective surfaces and sound obstacles or the like that affect sound as would be perceived by a listener in the virtual environment, the modifications to the sound may be computed, e.g. by the robotic interface 10's controller or by a computer responsible for the virtual environment context.

However in certain embodiments, such as when robotic interface 10 contributes to an augmented reality system where the virtual environment recreated shares some of the real environment of the robotic interface 10, the effect of the environment on the sound from the sound source may ideally be largely due to the actual real environment of the robotic interface 10. For example, in a surgical simulator the virtual environment may in fact be the exact room in the real environment where the robotic interface is located, except that in lieu of a hole in a wall in front of the robotic interface 10, a virtual operating theater is recreated by the robotic interface 10, and visually simulated by a head mounted display that shows the exact room (e.g. as captured by stereoscopic cameras in front of the head mounted system) of the real environment save for a bone saw in lieu of the robotic interface 10 and a body on which to perform surgery instead of the hole in the wall. Alternatively a visual feedback system may simply recreate a visual environment from artificial graphics (instead of cameras) that is similar to the real environment of the robotic interface 10.

In such a cases, the effect of the environment on the sound from the sound source may be accurately produced by the real environment, making reproduction of accurate sound feedback even easier (as no environmental effect needs to be artificially added) and more accurate.

The sound source in the virtual environment is a virtual sound source. In a first example where the virtual environment is a fictitious environment, e.g. a surgical simulator, virtual sound source may be fictitious as well, that is to say not corresponding to a real sound source in real time. Reproducing the desired sound effects can be done employing a pre-recorded sound database or generating artificial sounds based on a physical model of the real event. Such sound data can then be used systematically in the VR application generating the context of the virtual environment. Selection and/or generation of the sound outputs in a fictitious virtual environment context can be done at the robotic interface 10 or at an external source of environmental information, e.g. a computer generating the virtual environment context. In one particular example, a computer runs a simulation application and transmits to the robotic interface 10 haptic feedback data and environmental information in the form of sounds to play at the audio output device 70. The computer may itself have a bank of sounds to play, and optionally to mix together and may also optionally perform sound processing to modify the sounds from the bank to simulate an effect. The computer thus selects/generates the sounds to play and transmits them in a digital audio stream to the communication interface of the robotic interface 10 for reproduction/outputting by the audio output device 70. Instead of using a bank of sounds, the computer may instead generates artificial sounds based on an audio physics model, and likewise transmit them, e.g. as a digital audio stream.

In an alternative example, the controller of the robotic interface 10 may itself comprise a bank of sound or some (e.g. simple) sound processing/synthesizing logic, and may receive as environmental information not an audio stream but rather information with which to select/modify/generate sounds. For example the environmental information may include an index number indicating a particular sound in an indexed sound database to output and other information such as a length of time to play the sound or an identification of a modification scheme to apply to the sound. Alternatively still, such functionality could be built into the communication module of the audio output device 70 rather than in the controller.

In another embodiment the described interface is expanded by a device which is able to capture sound, e.g. a microphone, and two of interfaces are connected in a master-slave system as shown in FIG. 4. The microphone of the slave device captures the sound of the interactions between the slave interface and the real environment, while the speaker of the master device plays the captured sound at the proper place. The microphone may be tuned for close sounds to capture only the sounds of the interaction filtering the sounds of the environment.

As has been mentioned above, the first robotic interface 100 of the telemanipulation system 400 may be similar or identical to the robotic interface 10 of FIG. 1. In particular, the audio output device 70 is provided on the robotic interface 100 and may include any implementations and variants described in respect of the robotic interface 10 that are suitable to the telemanipulation setting.

In a telemanipulation implementation, the audio feedback provided by the audio output device 70 still be simulated in the manner described above, if no sound capture equipment exists on the remote device. In one example of such simulation, if two devices in a telemanipulation environment are interconnected, e.g. via a computer as described, the computer may generate or select the simulated sounds to output and provide them to the user-manipulated robotic interface in the manner provided herein.

However, in the example of FIG. 4, the audio feedback provided by the output device 70 is a reproduction of real sound captured in the real remote environment. In particular, robotic interface 100 is configured to output sound captured at the real environment of robotic interface 200.

An example will be provided with reference to FIG. 4, where in the telemanipulatioin environment the robotic interface 200 is a remote-operated bone saw and the robotic interface 100 serves as a virtual reality interface for operating the remote-operated bone saw. An environmental information sensor 270, in this case a microphone 271, on the robotic interface 200 captures sounds of the sawing operation which are provided as environmental information to the robotic interface 100 and output at the audio output device 70 to provide a user of the robotic interface 1000 with a realistic audio feedback simulating the sound of the remote telemanipulation (in this example, sawing) operation.

More particularly, the environmental information sensor 270 is located on the actuatable portion 255 of the robotic interface 200, located in this example in proximity to the saw to capture the sound of the sawing operation as environmental information. This information is transferred directly or indirectly to the robotic interface 100 and output at the audio output device 70, which is located on the user-manipulable portion 155.

The bone saw of this example is part of an actuatable portion 255 of the robotic interface 200 and moves in proportion to user manipulations of the user-manipulable portion 155. Since the audio output device 70 is located on the user-manipulable portion 155, it moves in proportion to the user manipulations. The audio output provided by the audio output device 70 may thus provide realistic sound to the user.

As described, the robotic interface 100 recreates a virtual environment that simulates the real environment of the robotic interface 200 and overlaps at least partially with the real environment of the robotic interface 100. The robotic interface 100 of this example is configured such that the audio output device 70 is collocated with the sound source in like manner as with the robotic interface 10 of FIG. 1. In this particular example, the sound source is the microphone 271 of the robotic interface 200 and the audio output device 70 is collocated with a place in the virtual environment corresponding to the location of the microphone 271. However, in other examples, the sound source may be a virtual source (e.g. if the simulated environment is fully or partially fictitious as in the example where a computer generates artificial audio feedback). In alternate embodiments, instead of collocating the audio output device 70 with the source where the sound is being captured, i.e. the microphone 271, the audio output device 70 may be collocated with another source in the virtual environment. For instance, using the bone saw telemanipulation example, the robotic interface 100 recreates a virtual environment where the user-manipulable portion is part of a bone saw. At the robotic interface 200, the microphone 271 may be located somewhere near, but not exactly on the saw, e.g. behind and to the side of the saw blade. In the virtual environment recreated by the robotic interface 100, if, for example, the saw blade is located directly in front of the grip 150 in the virtual environment, the source of the sound may be the virtual saw blade rather than the equivalent position of the microphone 271 in the virtual environment. Thus the audio output device 70 may be located directly in front of the grip 150 rather than where the microphone 271 would be located if it too were incorporated into the virtual environment. Thus the source of the sound may be a virtual source even in the telemanipulation example where the output of the audio output device 70 is a recreation of real sound captured by a microphone.

In the example of FIG. 4, the audio output device 70 is provided at a location on the user-manipulable portion 155 equivalent to a location of the microphone 271 on the actuatable portion 255 of the robotic interface 200. Since the robotic interface 200 and the robotic interface 100 are similar in structure, it is possible to locate the audio output device 170 and the microphone 271 at locations that are equivalent in that manipulation of the user-actuatable portion 155 will impart onto the audio output device 170 movement that corresponds to movement imparted by the actuatable portion 255 to the microphone 271. The movement of the audio output device 170 and the microphone 271 correspond in this example because they will both move in the same way relative to their respective real environments (e.g. move forward by a same amount, pivot by a same angle). However, in other examples, the movements may correspond to each other in other ways, e.g. if the robotic interface 100 is a scaled-down version of the robotic interface 200, the movement of the microphone 271 may be an upscaled version of the movement of the audio output device 70. In other embodiments the movement of one of these devices may correspond to each other by another relationship. Advantageously, moving or otherwise manipulating the user-manipulable portion 155 causes a movement in of the microphone 271 such that manipulating the user-manipulable portion 155 affects the output of the audio output device 170, and in particular it causes the audio output device 170 to output sound from a different place in the virtual environment, which in this example corresponds to a real remote environment.

The communication interface of the robotic interface 200 may be configured to transmit environmental information on the virtual environment. The controller of the robotic interface 200 may receive this environmental information, in this example audio data, from the microphone 271 and transmit it along with other data transmitted, if any.

In this example, the environmental information is audio data which is transmitted by the communication interface of the robotic interface 200 towards the robotic interface 100, directly in this example but it could be also sent to a computer or other intermediate device managing the communications and/or virtual environment context of the robotic interface 100 and robotic interface 200. The communication interface of the robotic interface 200 transmitting the environmental information may be the same communication interface described above, e.g. that is configured to receive state data, and may employ the same communication infrastructure, e.g. USB interface as described above.

In the present example the environmental information sensor 270 is integral with the robotic interface 200, and is in communication with the controller. In this example the controller transmits environmental information in like manner as it transmits other information, if any. For example it may transmit environmental information over a same serial (e.g. USB) connection as it transmits, e.g. haptic feedback data. In this example the environmental information sensor 270 is in electrical communication with the controller, specifically the connection to the controller comprises a wire connection over which analog signal providing an analog audio output of the environmental information sensor 270 is provided to the controller, which comprises an analog-to-digital encoder which converts the analog signal into a form suitable for transmitting over the communication interface. In an alternative embodiment, the environmental information sensor 270 may comprise logic for encoding the environmental information into suitable digital form and a communication module for communicating with the controller using any suitable protocol and technology (e.g. serial connection or Bluetooth™).

In an alternate example, like the audio output device of FIG. 3, the environmental information sensor 270 may be a detachable device that is provided with its own communication module. As has been described, the environmental information may be received at the controller from a communication module of the environmental information sensor 270. In this alternate example, however, the environmental information sensor 270 is configured for transmitting the environmental information directly to the recipient (e.g. external computer or remote robotic interface). As such the communication interface of the robotic interface 200 of this alternate example is a distributed communication interface, comprising a first module, e.g. within the controller, which receives state data and/or transmits feedback data, and a second module in the environmental information sensor 270 which transmits environmental information data. The communication module of the environmental information sensor 270 of his example may be configured for transmitting an analog signal, e.g. an analog audio signal to drive a speaker, or the communication module may be digital communication module comprising suitable hardware for transmitting data using digital data transfer technology (e.g. a WiFi interface and a serial, e.g. USB, interface). In such a case, the communication module comprises logic for receiving sensor information from the environmental information sensor 270 and for encoding it or otherwise translating it into a form suitable for transmitting. In particular in one example the communication module comprises an analog-to digital converter for converting an analog audio signal from a microphone to digital from and a digital encoder for encoding the digital audio signal into a compressed audio bitstream.

It will be appreciated the environmental information sensor 270 of this alternate example could also be used in a robotic interface where all communications pass through the robotic interface's (e.g. internal) controller. Indeed the environmental information sensor 270 may communicate using its communication module not with the intended recipient (e.g. computer intermediary or remote robotic interface) but with the controller which itself receives the environmental information data and transmits it, modified or not, to the intended recipient.

Where the communication module of the environmental information sensor 270 comprises a microphone 271 and the microphone is configured for outputting audio data in analog form, it may comprise an analog audio input interface, e.g. an analog sound output port, for example a 3.5 mm phone connector for outputting the audio data.

In certain examples, e.g. where the robotic interface 200 is also subject to manipulation by a user, the environmental information sensor 270 may also comprise local controls such as a microphone mute button to mute the microphone and prevent transmission of audio data.

Thus the robotic interface 100 receives environmental information data from the robotic interface 200 which in this example includes sound data representing real sounds captured live at the remote real environment of the robotic interface 200 and plays back these sounds in real-time at the audio output device 170 to generate realistic audio feedback and thus create a link between the real and the virtual environment (representing the remote real environment) of the robotic interface 100 and thereby creates a link between the real environment of the robotic interface 100 and the real environment of the robotic interface 200.

Although in the provided example of FIG. 4, the environmental information is provided as audio output directly at the robotic interface 100, in alternate embodiments, the environmental information, e.g. sound captured at the robotic interface 200 or generated at a computer, may be played back with a certain delay or with another effect modifying the environmental information (in this case sound). Such effects can be provided at the robotic interface 100 (e.g. by the controller or on logic provided on the audio output device) or it can alternatively be provided by a computer, e.g. by an intermediary computer effecting the connection between robotic interface 100 and robotic interface 200.

The interface can be further expanded by range sensors near to the place of interaction, which can be used to feedback distance with the attached speaker. In the examples provided above, the environmental information provided is sound/audio information representing sounds present in the virtual environment and/or real remote environment. In other embodiments, however, other types of environmental information may be provided. To this end, in the telemanipulation embodiments, the environmental information sensor 270 may include other types of sensors other than microphone 271.

Taking the telemanipulation example of FIG. 4 as an illustrative example, the environmental information data provided to the robotic interface 100 may comprise proximity data indicative of the proximity of an obstacle to the robotic interface 200 being manipulated remotely using the robotic interface 100. To this end, the information sensor 270 of the robotic interface 200 comprises a proximity (or range) sensor which detects the presence of nearby objects in a direction of possible motion of the actuatable portion 255 of the robotic interface 200.

In certain embodiments, the proximity data may simply be a Boolean value or equivalent (e.g. a flag) that simply indicates whether or not an object is within a certain proximity to the robotic interface 200 (and more particularly in this case to the actuatable portion 255). For such an embodiment, the audio output device 170 may simply output an indication of whether or not there is an obstacle in proximity to the robotic interface 200 (and more particularly here the actuatable portion 255 thereof). For example, the audio output device 170 may simply output a continuous beep when and for as long as an obstacle is within the detected proximity as determined from the Boolean environmental information data received.

In the present example, however, the robotic interface 200 comprises a proximity sensor that outputs information on the range of a detected object/obstacle, that is to say it outputs an indication of the proximity of the obstacle. In this example, the proximity sensor outputs to the controller of the robotic interface a numeric value in digital form, which the controller receives and transmits via the communication interface (in this example without significant modification, but in other examples it could apply transcoding) towards the recipient (e.g. intermediate computer, or in this example directly to the robotic interface 100).

Like with the example where the environmental information sensor 270 comprises microphone 271, the proximity sensor may alternatively be an analog device. Although here the environmental information sensor 270 already provides a digital numeric range value, in other examples the environmental information sensor 270 may output an analog signal indicative of range which the controller may convert to digital and encode as desired. Also, although in the present embodiment the environmental information sensor 270 provides environmental information via the controller 270 of the robotic interface 200, as described above the environmental information sensor 270 may provide environmental information data directly to the intended recipient via its own communication module. Also, as with the audio output device 70, the environmental information sensor 270 may be provided separately as a device that can be affixed to the robotic interface 200, including extensions, if desired, and suitable attachment mechanism (e.g. clamp, screw holes, etc. . . . ).

The robotic interface 200 outputs environmental information data indicative of a proximity of an obstacle to the robotic interface 200 and more particularly to at least a part of the actuatable portion 255. In this example, this is provided as digital data indicative of the range. The robotic interface 100 receives the environmental information data, in this example at the communication interface, in this case at the controller (but in alternate examples where the audio output device 170 communicates independently, this data could be received directly at the communication module of the audio output device 170). The environmental information data is translated into an audio signal, in this case at the controller of the robotic interface 100. Specifically, the controller generates a sound signal indicative of the proximity of the obstacle. The sound represents proximity, for example the sound may be of a pitch that is proportional to the proximity (so that as the actuatable portion 255 nears the obstacle the sound output at the audio output device grows increasingly high-pitch). In this example, however, the controller creates a sound signal of an artificial-sounding repeating beep whose repetition frequency is proportional to the proximity of the obstacle (so that the beep gets more and more frequent as the obstacle gets nearer) until the repetition becomes so frequent that the beep sounds in fact continuous right before the robotic interface 200 hits the obstacle. To this end the controller may include pre-recorded sound files and or logic for generating sounds. In one embodiment, the controller includes logic for generating the beep and logic for setting a counter as a function of the received environmental information data to count an inter-beep period such that the counter is decreased as the proximity of the obstacle is increased. A maximum counter value may include an “infinity” value, whereby the counter is considered never to expire.

The controller thus causes the audio output device to output sound information indicative of the environmental information, in this case the proximity of an obstacle.

The speakers, microphones and range sensors can be used in various combinations depending on the application.

In the above example the proximity data is provided in numerical or Boolean form. In alternate embodiments, however, the proximity data may be generated as or converted to sound data before being received at the robotic interface 100. For example the controller of the robotic interface 200 may output sound data indicative of proximity information directly to the robotic interface 100. In one example, the environmental information sensor 270 comprises both microphone 271 and the proximity sensor. In this example, the robotic interface 200 (e.g. its controller) may overlay onto the sound data output sound (e.g. beeps as described above) indicative of the proximity of an obstacle. As such the robotic interface 100 does not in this case require any special logic for interpreting proximity information data. By using artificial (unnatural sounding) beeps or like sounds, it is possible to clearly provide proximity information to a user and avoid confusion as to the meaning/source of the sound. In alternate embodiments where the robotic interface 100 and the robotic interface 200 are connected via an intermediate computer, the computer may generate sound data on the basis of proximity data if desired.

In a telemanipulation setting, the mental disconnection that can occur in a user between the manipulated device and the remote device may lead to impacts at the remote end. Even where visual feedback provide visual information on the remote end, imperfections in the visual information provided, glitches, or simply user error can cause the remote robotic interface to impact against obstacles which can be damaging to the remote robotic interface or surrounding objects. For example in a remote surgery application, impacting the wrong body part with surgical tools can cause injury to the patient being operated on. Advantageously by providing environmental information that includes proximity information, a user may be forewarned and avoid undesirable impacts.

Although proximity data was provided above in a telemanipulation setting, it will be understood that it may also be provided for fictitious virtual environment. For example where a computer generates a fictitious virtual environment, e.g. for robotic interface 10, the computer may calculate proximity information and provide proximity data to the robotic interface 10 for generating an audio output indicative of the proximity information. This may be useful, for example, in the context of training simulations for, e.g., remote medical operations. Thus although the examples with proximity data were provided in the context of a telemanipulation setting with reference to robotic interface 100, it will be understood that relevant details may also be employed in the context of robotic interface 10.

In another example of application, the proximity data may be provided as audio feedback to a visually impaired user such that the visually impaired user may obtain information about the proximity of the obstacles around the device in the virtual environment. Not only may this help a visually impaired user in a telemanipulation environment but this may also provide a training platform for such a user. In particular, in a fictitious virtual environment, a computer may generate audio feedback in the form of proximity data which may be provided to the visually impaired user in a training simulation to train the user to perform tasks that typically required visual information. For non-blind users, the proximity data may also be provided with visual feedback to train the user to correlate what he/she can see with proximity information.

The environmental information sensor 270 may include other environmental sensors to detect, for example, events, motion and position of the hidden objects, roughness and surface properties of objects upon contacts, vibrations, and operating state of a sound emitting elements. Environmental information data from any such sensors may be provided as described above and translated into an audio output at the audio output device of a robotic interface.

Although in the above example, only one audio output device was provided with only one speaker, it will be understood that the techniques taught herein can be expanded/multiplied to provide multiple audio output devices and/or multiple speakers on a robotic interface. Likewise a corresponding robotic interface in a telemanipulation setting may include multiple environmental information sensors. In one example, a user-manipulable robotic interface may include multiple audio output devices at different locations on the robotic interface for providing different audio feedback. For example, the robotic interface may comprise different audio output devices on different locations on a user-manipulable portion (or on plural user-manipulable portions), each being collocated with a source of sound in the virtual environment (e.g. there may be multiple environmental information sensors comprising microphones at locations on a remote robotic interface that correspond with the locations of the audio output devices in the user-manipulable robotic interface). In that example there may also be one or more audio output device on the user-manipulable robotic interface located not on user-manipulable portions (e.g. on the grounded portion), e.g. for outputting proximity information.

Thus more than one speaker could be used, as well, e.g. emitting sound of the motor of a bone saw and the sound of the sawing. This way the localization of the sound source can correspond fully to the real application, thus the aural experience can be optimized.

Although in the example above where proximity data is provided there was only one proximity sensor, in alternate examples multiple proximity sensors may be present in the robotic interface 200 (or a computer generating a fictitious virtual environment context may compute multiple types of proximity information). In such a case the proximity information from the different sensors may be translated into different sounds (at the robotic interface 200, by an intermediary computer or at the robotic interface 100) indicative of the different proximity information. For example, an audio output device may be caused to output a sound from a sound file stating in language the proximity information (e.g. “approaching obstacle on left”). Alternatively, the robotic interface 100 may be provided with multiple audio output devices located on portions of the user-manipulable portion 155 that correspond to the different proximities detectable at the robotic interface 200 (or computable at a computer), each of which being controlled to output a audio feedback related to its respective proximity. Thus a user may hear an audio warning from the direction of the obstacle detected. The sound source can thus also be attached to other moving or grounded parts of the robotic device, and it can also be used for other purposes than emitting sounds of the virtual world. Such integrated speakers can be multipurpose, since they can also give status feedback of the robot, and do other task, thus it makes the installation of additional speakers unnecessary.

The telemanipulation example of FIG. 4 was provided as a master-slave relationship where robotic interface 100 serves as the master device and robotic interface 200 serves as the slave device. However, as described above, in certain implementations of telemanipulation applications, the relationship may be bidirectional, where each device serves both as a slave being controlled by the other and as a master controlling the other. In such embodiments, both telemanipulation devices may comprise audio output devices and environmental information sensors as already described herein. Hence, the system may be, for example, a telepresence system which is an example of bidirectional telemanipulation system. For example, as shown on FIG. 1, the robotic interface 10 may include an environmental information sensor 76, in this case a microphone, along with the communication interface to transmit environmental information as described herein. Likewise, the robotic interface 100 of FIG. 4 may itself include an environmental information sensor 176, e.g. a microphone along with the communication interface to transmit environmental information as described herein. Likewise the robotic interface 200 may include an audio output device 276 for outputting environmental information, along with the communication interface for receiving environmental information data and any required logic for processing such data as described herein.

Thus instead of having unidirectional flow of environmental information, the environmental information flow may be bidirectional, each device providing environmental information to the other device and each device providing environmental information received from the other over a respective audio output device. The speakers, microphones and range sensors can be integrated into one device which also can serve for communication and as a controller for the speakers and sensors. Bidirectionally linked robotic interfaces can each contribute to respective virtual environments each emulating physical reality at the other's real environment.

Although in the telemanipulation examples provided above, a single master and a single slave device were provided, in alternative examples, there may be multiple slave devices being controlled by a single master. In that regards, state information representative of user manipulations may be provided to multiple slaves. In one simpler example the same information is provided to all slaves, each slave responding to it in the same manner, but in more complex examples, different slave devices may respond to different user manipulations. In such a case, the state information may also be divided with different portions transmitted to different slave devices. In such a distributed environment, the multiple slaves may together make up a single distributed slave device.

Moreover, although a single master system has been described, the use of multiple master devices is also possible. For example, multiple master devices operated by different users may be used to manipulate different portions of a single (or multiple) slave devices. In the example provided herein wherein the master device is used to control a bone saw, the bone saw may be a portion of a larger surgical robot comprising different tools which may be operated by different master devices, e.g. by for different users. Here too the different master devices may together make up a single distributed master device. Together the single or multiple master devices and the single or multiple slave devices may work in a network of devices and the overall system may comprise a network of master and slave devices.

With the disclosed solution the computational demands of the recreation of sounds in haptic virtual reality applications can be significantly reduced. No HRTFs and other algorithms have to be used for providing realistic spatial voice effects. This way development time and computation capacity can be saved because of the simplicity of the solution. The design of such a solution may be more compact relative to 3D sound systems, while the generated audio experience can be realistic, since only the emitted sound is artificial, and its position and motion is real.

Furthermore, with a speaker integrated into the kinesthetic interface installation and wiring of additional speakers can be avoided, which makes the invention useful for applications which have to be replaced often or installed at various places, or applications where usage of wires and speakers is not convenient (like industrial or dirty environments).

With additional microphones the recreation of sound effects can be made easier, since because of the advantageous placement of the microphone and the speaker the proper sound (related to the interaction) can be captured and the sound can be played at the proper place with realistic spatial characteristics.

The solution makes VR applications very flexible in the sense that speakers, microphones and range sensor can be used for arbitrary user defined tasks, thus the integrated speaker can also be used e.g. to feedback states of the kinesthetic interface (like booting, stand-by, etc).

The invention can be utilized at any haptic virtual reality application, where virtual sound source has to move together with the virtual tool simulated by the haptic interface, or it has to relate to the position and motion of the haptic interface in any other way. Thus it can be applied for gaming interfaces (e.g. guns of first person shooter games, interfaces for sport equipments), industrial training or master-slave applications (e.g. welding torch), medical virtual reality applications like surgical robots or trainer robots.

The above description has been provided for the purpose of illustrating, not limiting the invention which is defined by the appended claims.

What is claimed is:

1. A haptic robotic interface for recreating a virtual environment in a real environment
comprising:
a. a grounded portion configured for being in a grounded configuration with respect to the real environment in which the haptic device is located;
b. a user-manipulable portion movable by a user with respect to the grounded portion;
c. at least one haptic feedback device in mechanical connection to the user-manipulable portion, the haptic feedback device being actuatable under an input to apply a force to the user-manipulable portion to simulate the application of a force in the virtual environment;
d. an audio output device located on the user-manipulable portion providing environmental information on the virtual environment.

2. The haptic robotic interface of claim 1, wherein the environmental information comprises sound from a source in the virtual environment collocated with the user-manipulable portion in the real environment and wherein the audio output device is configured to provide a link between the virtual environment and the real environment by outputting the sound at the user-manipulable portion.

3. The haptic robotic interface of claim 1, wherein the environmental information comprises proximity information indicative of the proximity of an obstacle in the virtual environment and wherein the audio output device is configured to provide a link between the virtual environment and the real environment by outputting a sound indicative of the proximity of the obstacle in the virtual environment.

4. The haptic robotic interface of claim 1, further comprising a communication interface for receiving the environmental information.

5. The haptic robotic interface of claim 4, wherein the communication interface is a computer interface configured for communicating with a computer for receiving the environmental information from a virtual source generated at the computer.

6. The haptic robotic interface of claim 4, wherein the haptic robotic interface is a first robotic device, the communication interface is a robot-to-robot interface configured for communicating with a second robotic device for receiving therefrom the environmental information.

7. The haptic robotic interface of claim 4, wherein the communication interface comprises an analog sound input port.

8. The haptic robotic interface of claim 4, wherein the communication interface is a digital interface configured for receiving haptic feedback data and environment information data.

9. The haptic robotic interface of claim 8, wherein the communication interface comprises a USB interface.

10. The haptic robotic interface of claim 1, wherein the haptic robotic interface is a kinesthetic robotic interface, the haptic feedback device being further in mechanical connection with the grounded portion for applying a force onto the user-manipulable portion relative to the grounded portion.

11. The haptic robotic interface of claim 10, wherein the haptic feedback device comprises a step motor having a stator in rigid connection with the grounded portion and a rotor connected to the user-manipulable portion.

12. The haptic robotic interface of claim 1, wherein the user-manipulable portion comprises an extension on which is mounted the audio output device, the extension forming a part of the user-manipulable portion and moving therewith in relation to the grounded portion.

13. The haptic robotic interface of claim 1, wherein the audio output device is a first audio output device, the haptic robotic interface comprising at least a second audio output device.

14. A telemanipulation system comprising:
a. a first robotic interface for recreating in a first real environment a virtual environment simulating a second real environment comprising:
i. a grounded portion configured for being in a grounded configuration with respect to the first real environment;
ii. a user-manipulable portion movable by a user with respect to the grounded portion;
iii. at least one haptic feedback device in mechanical connection to the user-manipulable portion, the haptic feedback device being actuatable under an input to apply a force to the user-manipulable portion to simulate the application of a force in the virtual environment; and
iv. an audio output device located on the user-manipulable portion providing environmental information on a remote environment;
v. a first robotic interface communication interface configured for:
1. transmitting in response to a user manipulation a user state data indicative of the user manipulation, and
2. receiving environmental information data;
b. a second robotic interface for being controlled in the second real environment comprising:
i. an actuatable portion configured to be actuated in the second real environment in response to actuation data;
ii. a grounded portion configured for being fixed relative to the actuatable portion such that when actuated the actuatable portion moves in relation to the grounded portion;
iii. an environmental information sensor configured for sensing an environmental condition and for generating an output representative of the environmental condition;
iv. a second robotic interface communication interface configured for:
1. receiving from the first robotic interface the state data from the first robotic interface, deriving therefrom actuation data, and providing the actuation data to the actuatable portion, and
2. generating on the basis of the output of the environmental sensor environmental information data for transmission to the first robotic interface.

15. The telemanipulation system of claim 14, wherein the second robotic interface environmental information sensor comprises a microphone as a sound source in the second real environment, the environmental information data comprising sound data; and wherein the audio output device comprises a speaker located on the user-manipulable portion at a location corresponding to the location of the microphone on the second robotic interface to recreate sound in the virtual environment at a location corresponding to the sound source in the second real environment being simulated.

16. The telemanipulation system of claim 14, wherein the second robotic interface environmental information sensor comprises a proximity sensor for detecting the proximity of an obstacle to the actuatable portion, the environmental information data comprising proximity data; and wherein the first robotic interface is configured to output at the audio output device an audible indication of a proximity of the obstacle.

17. The telemanipulation system of claim 14, wherein the second robotic interface communication interface comprises an analog audio output interface for outputting analog audio over a communication link, and wherein the first robotic interface communication interface comprises an analogue audio input interface for receiving analog audio and providing it to the audio output device.

18. The telemanipulation system of claim 14, wherein the second robotic interface communication interface is a digital interface configured for receiving digital state data and for transmitting digital environmental information data, and wherein the first robotic interface communication interface is a digital interface configured for transmitting digital state data and for receiving digital environment information data.

19. The telemanipulation system of claim 18, wherein the first robotic interface communication interface and the second robotic interface communication interface each comprise a wifi interface.

20. The telemanipulation system of claim 14, wherein the first and second robotic interfaces are bidirectional robotic interfaces, each being configured for assuming both the master and the slave status in a telemanipulation operation, wherein the virtual environment recreated by the first robotic interface is a first virtual environment, the second the second robotic interface recreating a second virtual environment simulating the first real environment, wherein the second robotic interface comprises
a. a grounded portion configured for being in a grounded configuration with respect to the second real environment;
b. a user-manipulable portion movable by a user with respect to the grounded portion;
c. at least one haptic feedback device in mechanical connection to the user-manipulable portion, the haptic feedback device being actuatable under an input to apply a force to the user-manipulable portion to simulate the application of a force in the second virtual environment; and
d. an audio output device located on the user-manipulable portion providing environmental information on a remote environment;
and wherein the second robotic interface communication interface is configured for:
i. transmitting in response to a user manipulation state data indicative of the user manipulation, and
ii. receiving environmental information data;
and wherein the first robotic interface comprises:
e. an actuatable portion configured to be actuated in the first real environment in response to actuation data;
f. an environmental information sensor configured for sensing an environmental condition and for generating an output representative of the environmental condition;
and wherein the second robotic interface communication interface is configured for:
i. receiving from the second robotic interface the state data from the second robotic interface, deriving therefrom actuation data, and providing the actuation data to its respective actuatable portion, and
ii. generating on the basis of the output of the environmental sensor environmental information data for transmission to the second robotic interface.

21. The telemanipulation system of claim 20, wherein the user-manipulable portion of the first robotic interface is the actuatable portion of the first robotic interface, and the user-manipulable portion of the second robotic interface is the actuatable portion of the user-manipulable portion, the force-feedback devices of the first and second robotic interfaces, respectively, providing the actuating force for actuation.

22. A method of creating a realistic virtual environment using a haptic robotic interface device in a real environment, the method comprising:
a. accepting user manipulations on a haptic robotic interface at a user-manipulable portion, the user manipulation corresponding to manipulation commands for an object in the virtual environment;
b. providing haptic feedback to the user-manipulable portion to simulate the virtual environment;
c. receiving from an external source environmental information data representative of environmental information;
d. providing at an audio output device on the user-manipulable portion an audio representation of the environmental information.

23. The method of claim 22, wherein the environmental information data is representative of a sound at a particular sound source in the virtual environment, wherein providing at an audio output device on the user-manipulable portion an audio representation of the environmental information comprises outputting the sound at an audio output device that is collocated in the real environment that is collocated with the sound source in the virtual environment.

24. The method of claim 22, wherein the environmental information comprises proximity information indicative of the proximity of an obstacle in the virtual environment, and wherein providing at an audio output device on the user-manipulable portion an audio representation of the environmental information comprises outputting a sound indicative of the proximity of the obstacle in the virtual environment.
